(19) United States
(12) Patent Application Publication
(10) Pub. No.: US 2012/0237642 A1
(43) Pub. Date: Sep. 20, 2012

(54) Meat-Based Semi-Moist Animal Food Product and Method for the Production Thereof

(76) Inventor: Heinz Johannes Gardewin, Oldenburg (DE)

(21) Appl. No.: 13/419,996

(22) Filed: Mar. 14, 2012

(30) Foreign Application Priority Data
Mar. 15, 2011 (EP) 11002117.7

(51) Int. Cl. A23K 1/10; A23K 1/18; A23P 1/12; B65D 85/00

(52) U.S. Cl. 426/106; 426/641

(57) ABSTRACT

A nutritionally suitable, semi-moist animal foodstuff which is similar to natural animal food meats and having a very high meat content is provided, which has good acceptance with the animal food animal and a corresponding structure. The semi-moist animal food product does not need cereal contents, cereal products and binders. The novel semi-moist animal food product is produced by extrusion cooking, wherein the extruder is charged at least with the following ingredients:
a) at least one component of the group dry meat, meat meal, dry fish, fish meal,
b) meat and/or fish,
c) optionally water or steam, where not introduced by or in combination with a) or b).

Components a), b) and c) together make up at least 80% by weight of the ingredient mass. In addition, additives, such as flavourings, probiotics and the like can be present.

The invention relates to a method for producing a meat-based, cereal-free semi-moist animal food product by extrusion, a semi-moist animal food product that is obtainable by the method and has a content of at least 80% by weight of fresh or pretreated meat, and the use of this animal foodstuff for cats, dogs and other meat-eating pets, in the form of complete food or snacks.

Semi-moist animal food is taken to mean an animal food, the moisture of which is between that of dry animal food and moist animal food. Dry animal food generally contains between 6 and 10% by weight water (residual moisture 6 to 10%). In contrast, semi-moist products contain between 15 and 50% by weight of water.

Cats and dogs are carnivorous species which naturally feed principally on meat, i.e. on prey species including stomach contents. Meat and also fish, that is to say animal proteins, in addition provide high acceptance based on the feeding behaviour of the animals. Therefore, it is nutritionally logical to develop an animal foodstuff having a high meat content, possibly enriched with fish, and therefore having a high content of animal protein, which at the same time does not need cereals or cereal products, and therefore has a very low content of carbohydrates.

Customary pet food, in contrast, in the case of the dry and semi-moist products, has a not inconsiderable content of cereals or cereal ingredients, in particular starch, although these components for the most part are not part of the natural diet of the animals fed in this manner. In addition, it has now been recognized that for carnivorous animals, pure meat meals are important for health. In addition to fresh animal food and tinned animal food, there is therefore a requirement for complete animal food and snacks having a very high meat content that do not contain cereal products, and preferably also no sugar.

Semi-moist animal food products are frequently obtained by extrusion cooking. Such methods have long been used for various food products, and so methods and apparatuses that have been proven in practice are available. One example of an extrusion-cooking method is specified by DE 36 36 867.

Texture, elasticity and appearance of the extruded products depend not only on the ingredients but also on the extrusion conditions. Thermal and mechanical energy are introduced via the extruder. Shear forces act on the extruded material which is mixed, kneaded and transported in one step. In the course of extrusion cooking, frequently an expansion occurs, but this can be counteracted by the build up of a compression pressure in the extruder.

The semi-moist animal food product can be pressed at the exit of the extruder through a die to form an extrudate which can then be sliced and optionally dried. What is desired is a consistency in which the product has good cohesion, without being too hard, brittle, dry or friable. What is sought is a soft, moist, elastic and nevertheless firm, non-melting or disintegrating product which comes close in consistency thereof to natural fresh meat pieces.

U.S. Pat. No. 4,190,679 discloses a soft elastic animal food product made of meat-like pieces, which is produced by an extrusion-cooking method. For establishing the desired texture, cereal flours are used in combination with a plasticizing polyol.

U.S. Pat. No. 3,380,832 specifies an extrusion cooking method in which the starch can be omitted, if the cohesion within the product is ensured by a casein adhesive such as sodium casein. However, for a natural-like animal food product for carnivores, the presence of casein and other binders is undesirable.

The object of the invention is therefore to provide a nutritionally suitable, natural animal food-meat-like, semi-moist animal foodstuff having a very high meat content, good acceptance and corresponding structure which does not contain cereal fractions or cereal products. In addition, the semi-moist animal foodstuff should be as free as possible from binders.

The object is achieved by a method for production of a meat-based, semi-moist animal food product by extrusion, in which an extruder is charged with at least the following ingredients:
a) at least one component of the group dry meat, meat meal, dry fish, fish meal,
b) meat and/or fish,
c) optionally water or steam, if a sufficient water content is not already provided by meat and/or fish,
   with the exclusion of cereals, cereal products and concentrated vegetable protein, wherein the components a), b) and c) together make up at least 80% by weight of the mass of ingredients,
   and in that the ingredients are mixed with supply of thermal and mechanical energy and are pressed through an extrusion die to form an extrudate, wherein in at least one zone of the extruder a pressure of 20 to 40 bar is built up and the mass is subjected to a temperature between 80 and 130° C., preferably between 80 and 110° C., for a time that is sufficient to comply with food-processing requirements.

The extrusion here is, in particular, what is termed “extrusion cooking”. In this case, generally heatable extruders are used. Since the temperatures can also be entirely below 100° C., this method can also be termed relatively low-temperature extrusion cooking. With respect to the temperature profile, various treatment modes for the extrusion material are conceivable. Depending on the extrusion time and heat profile along the extruder, the extrusion can be performed, for example at overall mild temperatures, preferably then over a relatively long treatment time. Treatment can also be performed for a short time at relatively high temperatures, and, moreover, at relatively low temperatures. In a preferred treatment form, in at least one section of the extruder, a core temperature of the extrusion material of at least 90° C. is established.

Even without the presence of starch, other processed carbohydrates or binders, the thermal and mechanical energy introduction via the extruder plasticises the mass and forms a homogeneous, inherently cohesive, elastic product. This is achieved according to the invention by the interaction of the dry and fresh meat components with the water and/or steam under the extrusion conditions.

Meat and meat meal can each, and independently of one another, originate from different animal species. Mixtures of a plurality of species of meat and meat meal or of fresh and dry components can also be used.

Suitable types are, for example, poultry, beef, lamb, game, pork.

“Meat” here means: all parts which are permitted for animal food processing, inter alia warm-blooded animals, with the following exceptions being made: hide, claws, hair, horn, feathers, teeth, hoofs, beaks, gastrointestinal contents, added fat, added blood, added bones and bone meals.

“Fish” here means: whole fish, fresh or dry, or parts thereof.

The ingredients “meat” and “fish” of group b) in each case have a higher moisture content than the dry ingredients of group a), more precisely preferably a moisture content typical for moist animal feedstuffs which, in particular, is a natural or approximately natural moisture content. Preferably, the ingredients of group b) are fresh meat and/or fresh fish (alternatively frozen).

“Dry meat” means: meat (chunked) dried by removal of water, also in heat, or in the air, “dry fish” is understood correspondingly. Dry meat and dry fish are optionally comminuted in prepared steps. This can be omitted if the material is so brittle and friable that it disintegrates sufficiently on being transported and supplied into the extruder.

“Meat meal” and “fish meal” are finely ground dry meat and dry fish products.

“Cereals” here means: all components of cereal plants, in particular grains, that are suitable for animal food.

“Cereal products” here means: any form of ground, coarsely comminuted, processed cereals such as coarse meal, bran, flours, and all types of extracts, including starch and starch products.

“Concentrated vegetable protein” comprises all vegetable ingredients having a high protein content, from approximately 40% dry matter, in particular soy and soy protein, other isolated proteins and protein hydrolysates.

The ingredients a) and/or b), in a development of the invention, can be premixed with water or preconditioned with steam. Other preparation measures are not excluded. The meat used or the fish can first be cut into pieces, mixed with water, emulsified and/or preplasticized. Depending on the starting material, alternatively, water can also be removed.

The meat, or the fish or fish meat as appropriate, can be used completely or in part in the frozen state, i.e. frozen and fresh meat can be mixed in such a manner that a chilled mixture results. However, it is also possible to proceed using exclusively frozen or exclusively non-frozen meat.

The weight ratio of a) to b), without taking into account the added water, is preferably greater than 0.8, further preferably greater than 1, further preferably 3:1 to 1:1, particularly preferably 2.5:1 to 1.5:1. Preferably, at least 4% fish is present in a fish-containing animal food product.

In addition, additives that are customary in the animal foodstuff industry can be added, in particular flavourings, natural or synthetic dies, inactivated yeast or yeast extracts, plant extracts and/or plant concentrates, in particular vegetable extracts, such as paprika extract, beetroot extract, celery extract, carrot extract, tomato extract, etc., tomato puree, thickened vegetable juice.

Preservatives can be added.

Alternatively thereto, the method is carried out without preservatives. Via the extrusion (cooking), the product, as it leaves the extruder, is thus first safe from the hygiene aspect and can safely be packaged from the food aspect under production conditions oriented thereto. In order to achieve a relatively long shelf life, the product can then be gas-treated in the package.

Sugars can also be added to the ingredient mass or the extrusion material. Alternatively, and currently preferably, no sugar is added, further preferably no sweetener and no sugar replacers.

In further advantageous embodiments, functional ingredients such as probiotics, for example, can be added. These are taken to include, inter alia, vitamins, minerals, omega-3 fatty acids, probiotic fibres and probiotic microorganisms.

In addition, it is preferred to use no binders such as carrageenan, gelatin, agar-agar, caseinates or casein-based production aids or pectin.

According to a further embodiment of the invention, as additive, no isolated celluloses and no microbial polysaccharides are used.

Preferably, no milk products and no milk protein are added.

In addition, no emulsifiers should be added to the semi-moist animal food product; such emulsifiers are not necessary in the method. Likewise, preferably, fermentatively acting acidulates are dispensed with, since they modify the structure or the structure of the product.

The freshly generated semi-moist animal food product preferably has a moisture content of 15 to 45% by weight.

The semi-moist animal food product can be shaped on exiting from the extruder. Using specially shaped dies (die plates) special extrudate cross sections can be achieved.

The product can be further processed after exit from the extruder. Preferably, it is provided that the extruded animal food product extrudate is chopped or sliced. The resultant extrudate sections can be directly packaged. Drying can be dispensed with.

The sliced, elastically moist product can, in addition, if desired, be thermally reshaped. In this manner, pieces, e.g. cushions, transformed using appropriate shaping tools are obtained. Also, shapes can be stamped out from the extrudate sections.

According to a particularly preferred procedure, the extrusion is carried out using a 2-shaft extruder or else 2-screw extruder, also called a double-screw extruder. The screws can be constructed so as to engage with one another and can be constructed to be co-rotary or counter-rotary.

The method is preferably operated using an extruder on which zones that are brought to and maintained at different temperatures are established during the extrusion. Further preferably, at least one working zone and at least one compression zone are present.

Steam or water can be taken off from the extruder, more precisely, particularly preferably in or immediately upstream of the end zone (if present the compression zone). Also, if required, steam can be fed at one or more addition sites along the extruder. Both measures serve for establishing the desired moisture content.

It is currently considered to be particularly advantageous if the specific mechanical energy (SME) input which is introduced during the extrusion is between 10 and 150 Wh/kg, further preferably 30 to 80 Wh/kg. The SME is a good measure of the effect of the extrusion conditions on the structure or texture of the product.

In particular, using the above described method, a novel semi-moist animal food product is obtained which consists virtually exclusively of meat components, that is to say fresh or moist-preserved (e.g. frozen) and dried, optionally ground to meal, meat (optionally including fish) and water. In the preferred embodiments, the animal food product, as is obtained from the extruder, or fresh after an aftertreatment—has a content of at least 80% by weight of meat components, namely fresh or pretreated meat. In particularly preferred examples, the product contains at least 90% by weight of meat components, wherein in each case fresh fish components can be counted as the meat components. The animal food product can be present or generated in chunk form, for example in ready-to-eat pieces.

The semi-moist animal food product can be coloured in one colour or be multicoloured using natural dyes. Preferably, it is enclosed in a film package, in particular a flexible pouch package, or a deep-tray package and is further preferably gas treated.

The novel semi-moist animal food product can, in addition, be enclosed with other animal food products in retail units, or be offered in mixed animal foodstuffs.

The semi-moist animal food product according to this invention can particularly advantageously be used as cat food, dog food, or animal food for other carnivorous pets in the form of a complete animal food or snacks.

The invention further comprises packaging units which, in addition to the semi-moist animal food product itself, within a packaging volume contains a sauce (gravy) together with the animal foodstuff, or separately in an additional compartment of the package.

Hereinafter, the invention will be described in more detail with reference to example methods and formulas which are intended to illustrate in more detail the field of application and the possible embodiment variants of the invention. On the basis of the above considerations, those skilled in the art can find further possible embodiments using their specialist knowledge.

### FORMULA EXAMPLES

(all data in % by weight)

### Example 1

| | |
|---|---|
| Meat meals (e.g. beef, pork, poultry) | 55.00 |
| Meat and animal by-products (fresh and frozen), | 35.00 |
| (e.g. beef, lamb, game, poultry) | |
| Fish and fish by-products (frozen or fish meal) | 4.00 |
| Yeast (inactivated) | 3.00 |
| Mixture of natural flavourings | 2.00 |
| Plant extracts (e.g. paprika extract) | 1.00 |

### Example 2

| | |
|---|---|
| Meat meals (e.g. beef, pork, poultry) | 58.00 |
| Meat and animal by-products (fresh and frozen), | 37.00 |
| (e.g. beef, lamb, game, poultry) | |
| Plant extracts (e.g. beetroot extract) | 2.00 |
| Mixture of natural flavourings | 2.00 |
| Yeast (inactivated) | 1.00 |

Example 3

| | |
|---|---|
| Meat meals (e.g. beef, pork, poultry) | 69.00 |
| Meat and animal by-products (fresh and frozen), | 28.00 |
| (e.g. beef, lamb, game, poultry) | |
| Mixture of natural flavourings | 2.00 |
| Yeast (inactivated) | 1.00 |

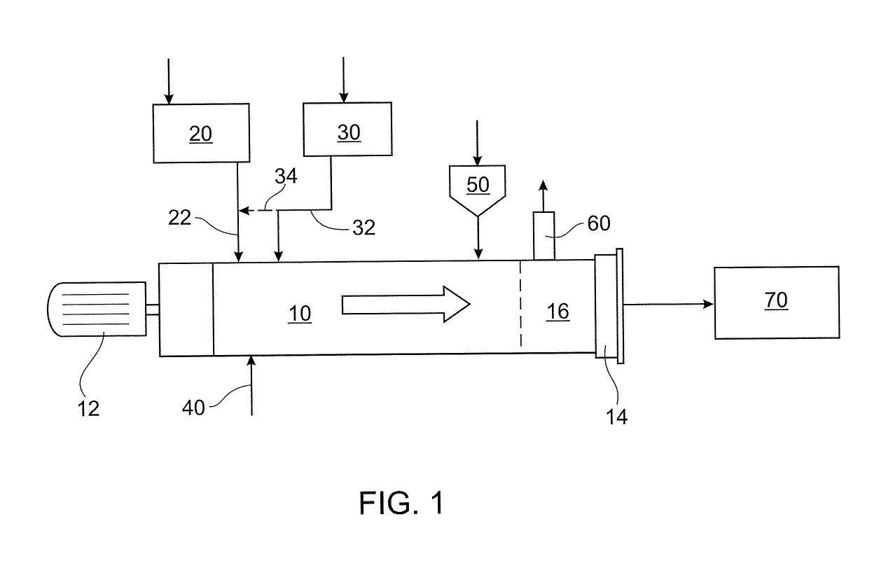

FIG. 1 shows a schematic presentation of the extrusion method according to this invention.

The semi-moist animal food product is produced on a 2-shaft relatively low-temperature extruder cooker 10 having a drive 12 and a die plate 14 arranged at the exit, which die plate is equipped with a plurality of zones which can be brought to and maintained at different temperatures, which are not shown here in detail. The transport direction runs in the FIGURE from left to right. Along the operating route, first the meat components are applied. The fresh meat ingredients are situated in container 20 and are fed from there to the extruder 10. The transport proceeds using a pump 22 (peristaltic pump or screw pump) which is not shown in more detail. Instead of the container 20, a conditioner, e.g. a cutting agitator or an emulsifying apparatus can also be provided. In this case the fresh meat, together with frozen fresh meat is finely comminuted and pre-emulsified in order to reduce the particle size and to harmonize the consistency, especially if bone fragments and cartilage are present. The container 20 or the conditioner can be cooled, but this can be omitted if frozen meat is added to the fresh meat, or if only frozen meat is being used.

Fine ground meat meal is fed to the extruder 10 from a bulk goods container 30 or a sack, via the transport path 32. The meat meal can either be fed to the extruder separately or it is mixed in advance with the fresh meat component, as is indicated using a connecting line 34 shown dashed.

If a plurality of fresh meat ingredients and/or a plurality of meat meals or fish meals are used, in each case a plurality of containers 20 and 30 can be provided in parallel.

Via feed sites 40, water can be fed. Alternatively, water is introduced into the method or the extruder 10 via the fresh meat emulsion, which can be produced with additionally added water. The components a), b) and c) of the starting mixture for the animal foodstuff are therefore added in closely adjacent feed sites, or else already premixed. They then pass through the working section of the extruder 10 together and are mixed. The mechanical energy using shear forces is fed to the resultant mass, mediated by processing with a screw or double screw. Downstream of the feed points there are situated one or more zones of the extruder which can be brought to and maintained at a temperature. There, thermal energy is additionally introduced. The extrusion material is cooked during the mixing and mechanical treatment, and the proteins are denatured in this case. If flavourings and further ingredients have not been added to the fresh meat container 20, they can be fed from the container 50 to the extruder 10 downstream of the main ingredient addition. Depending on the temperature profile, this can be expedient, especially to safeguard flavourings. In a compression region 16 of the extruder 10, a compression takes place and the pressure is increased just before the exit die plate 14. In this example, in the extruder end zone, a pressure of 25 to 35 bar is set just before the exit of the extrudate. For the pressure regulation, a steam valve 60 can be provided in the compression region 16, or directly upstream thereof. Steam is taken off; no expansion of the product takes place.

Using selected die plates 14, shaping of the extrudate is possible, in such a manner that, for example, a heart-shaped or star-shaped cross section results. Subsequently to the die plate 14, rotary blades are arranged which cut the extruded product extrudate to give animal food bodies of any desired length. The size of the animal food bodies is set in such a manner that they can be consumed optimally by the animal.

The end product, that is to say the semi-moist animal foodstuff, after it leaves the extruder, is fed to post-processing and/or packaging units, here designated collectively 70.

### Process Parameters:

Screw drive: 500 rpm;
Pressure during the mixing phase: 20 to 30 bar;
Pressure during the compression phase: 25 to 35 bar;
Process temperature in zone close to the end: 80 to 95° C.

1. Method for production of a meat-based, semi-moist animal food product by extrusion, comprising the steps of:
charging an extruder with at least the following ingredients:
a) at least one component of the group dry meat, meat meal, dry fish, fish meal,
b) meat and/or fish,
c) optionally water or steam, where not introduced by or in combination with a) or b),
wherein with the exclusion of cereals, cereal products, and concentrated vegetable protein, the components a), b) and c) together make up at least 80% by weight of the mass of ingredients, and
mixing the ingredients with supplying one or both of thermal and mechanical energy to form a mixture, and
pressing the mixture through a die of an extruder to form an extrudate,
wherein in at least one zone of the extruder a pressure of 20 to 40 bar is built up and the mixture is subjected to a temperature between 80 and 130° C. for a time that is sufficient to comply with food-processing requirements.

2. Method according to claim 1, wherein the ingredients a) and/or b) are premixed with water or preconditioned with steam.

3. Method according to claim 1, characterized in that the meat is used completely or in part in the frozen state.

4. Method according claim 1, wherein a weight ratio of a) to b) without taking into account added water is greater than 0.8.

5. Method according to claim 1, further comprising adding one or more additives that are customary in the animal foodstuff industry to said ingredients.

6. Method according to claim 1, wherein an end product of said charging, mixing and pressing steps has a moisture content of 15 to 45% by weight.

7. Method according to claim 1, further comprising slicing said extrudate.

8. Method according to claim 7, further comprising thermally reshaping slices of said extrudate.

9. Method according to claim 1, wherein zones of said extruder are brought to and maintained at different temperatures, and wherein at least one working zone and at least one compression zone are present in said extruder.

10. Method according to claim 1, wherein during said pressing step a specific mechanical energy (SME) input is between 10 and 150 Wh/kg.

11. Semi-moist animal food product, produced by the process of
charging an extruder with at least the following ingredients:
a) at least one component of the group dry meat, meat meal, dry fish, fish meal,
b) meat and/or fish,
c) optionally water or steam, where not introduced by or in combination with a) or b),
wherein with the exclusion of cereals, cereal products, and concentrated vegetable protein, the components alb) andup at least 80% by weight of the mass of ingredients, and
mixing the ingredients with supplying one or both of thermal and mechanical energy to form a mixture, and
pressing the mixture through a die of an extruder to form an extrudate,
wherein in at least one zone of the extruder a pressure of 20 to 40 bar is built up and the mixture is subjected to a temperature between 80 and 130° C. for a time that is sufficient to comply with food-processing requirements,
wherein said extrudate has a content of at least 80% by weight of meat components, with the exclusion of cereals, cereal products, and concentrated vegetable protein.

12. Semi-moist animal food product according to claim 11, wherein said extrudate is coloured in one colour or is multicoloured using natural dyes.

13. Semi-moist animal food product according to claim 11, further comprising a package selected from a flexible pouch package, a deep-tray package, and a tin, said extrudate being enclosed in said package.

14. Semi-moist animal food product according to claim 11, wherein said extrudate is formulated for use as cat food, dog food, or animal food for carnivorous pets.

15. Semi-moist animal food product according to claim 11, further comprising a in that the packaging unit containing said extrudate, wherein within a package volume of said packaging unit there is either a sauce together with the extrudate or a sauce stored separately from said extrudate in an additional compartment of the packaging unit.

16. Method according to claim 5 wherein said additives are selected from the group consisting of flavourings, natural or synthetic dies, inactivated yeast or yeast extracts, plant extracts and/or plant concentrates, preservatives, sugars, and functional ingredients excluding binders and emulsifiers
